(19) United States
(12) Patent Application Publication
(10) Pub. No.: US 2010/0280914 A1
(43) Pub. Date: Nov. 4, 2010

(54) SECURITY SYSTEM AND METHOD INCLUDING ALERT MESSAGES

(76) Inventor: Mark Carlson, Half Moon Bay, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/435,195

(22) Filed: May 4, 2009

(51) Int. Cl. G06Q 30/00; G06Q 20/00; H04M 1/00

(52) U.S. Cl. 705/26; 705/44; 455/550.1

(57) ABSTRACT

A server computer is disclosed. It includes a processor; and a computer readable medium coupled to the processor. The computer readable medium includes (i) code for receiving an authorization request message, wherein the authorization request message is associated with a transaction, (ii) code for sending an authorization response message authorizing the transaction, (iii) code for sending a transaction alert message to a consumer device, where the transaction alert message includes information identifying the transaction, (iv) code for receiving an alert response message indicating that the transaction is not authorized, (v) code for sending a termination message, and (vi) code for receiving a chargeback message after sending the termination message.

### CROSS-REFERENCES TO RELATED APPLICATIONS

NOT APPLICABLE

### BACKGROUND

Credit card fraud is a major problem for payment entities, merchants and consumers. Fraudulent transactions cost payment entities and merchants many billions of dollars a year. In addition, fraudulent transactions can cause an innocent and responsible consumer to become labeled a bad credit risk.

In the past, schemes have been proposed by which a user is asked to authenticate transactions. According to such schemes, the transaction is not processed until either an acceptance or repudiation is received from the consumer. One problem with such schemes is that they can significantly increase the time delay between when an order is placed by the consumer and when the order is fulfilled. Even if the scheme includes a time-out period after which an order proceeds if no response is received from the consumer, fulfillment of the order can be delayed by the duration of the time-out period

Embodiments disclosed below address these and other problems, individually and collectively.

### SUMMARY

Systems, devices and methods for improved transactions are disclosed. In embodiments of the invention, an alert message can be sent to a consumer's phone indicating that a transaction has taken place using the user's portable consumer device. The user may directly respond to the alert message indicating that the transaction is authorized or not authorized by the consumer. If it is not authorized, the user's response to the alert message may be used to automatically initiate a chargeback process after the transaction was otherwise authorized by an issuer associated with the portable consumer device.

One embodiment of the invention is directed to a server computer comprising: a processor; and a computer readable medium coupled to the processor, wherein the computer readable medium comprises code executable by the processor, the computer readable medium comprising (i) code for receiving an authorization request message, wherein the authorization request message is associated with a transaction, (ii) code for sending an authorization response message authorizing the transaction, (iii) code for sending a transaction alert message to a consumer device, wherein the transaction alert message includes information identifying the transaction, (iv) code for receiving an alert response message indicating that the transaction is not authorized, (v) code for sending a termination message, and (vi) code for receiving a chargeback message after sending the termination message.

Another embodiment of the invention is directed to a method comprising: receiving an authorization request message at a server computer, wherein the authorization request message is associated with a transaction; using the server computer, sending an authorization response message authorizing the transaction; using the server computer, sending a transaction alert message to a consumer device, wherein the transaction alert message includes information identifying the transaction; receiving an alert response message at the server computer indicating that the transaction is not authorized; using the server computer, sending a termination message; and receiving a chargeback message at the server computer after sending the termination message.

Another embodiment of the invention is directed to a server computer comprising: a processor; and a computer readable medium coupled to the processor, wherein the computer readable medium comprises code executable by the processor, the computer readable medium comprising (i) code for sending an authorization request message associated with a transaction, (ii) code for receiving an authorization response message approving the transaction, (iii) code for receiving a termination message after receiving the authorization response message, (iv) code for initiating a termination process for the transaction, and (v) code for sending a chargeback message.

Another embodiment of the invention is directed to a method comprising: using a server computer, sending an authorization request message associated with a transaction; receiving an authorization response message approving the transaction at the server computer; receiving a termination message at the server computer after receiving the authorization response message; initiating a termination process for the transaction; and sending a chargeback message.

Further details regarding embodiments of the invention are provided below in the Detailed Description with reference to the figures.

### BRIEF DESCRIPTION OF THE DRAWINGS

FIG. 1 is a block diagram showing a system according to an embodiment of the invention.

FIG. 2 shows a flowchart illustrating a process according to one embodiment of the invention.

FIG. 3 shows a flowchart illustrating a process according to another embodiment of the invention.

FIGS. 4(a) and 4(b) show diagrams of portable consumer devices.

FIG. 5 is a block diagram of a computer apparatus.

### DETAILED DESCRIPTION

The description below is directed to a method and system for authenticating a transaction such as a payment transaction for products or services. Although payment transactions are discussed in detail, it should be understood that other embodiments of the invention can be used in other transactions such as money transfer transactions, access transactions (e.g., obtaining access to a particular location or venue) and the like. In addition, although card-not-present transactions are discussed in detail, it should be understood that other embodiments can be used in transactions in which the card is present.

I. Systems

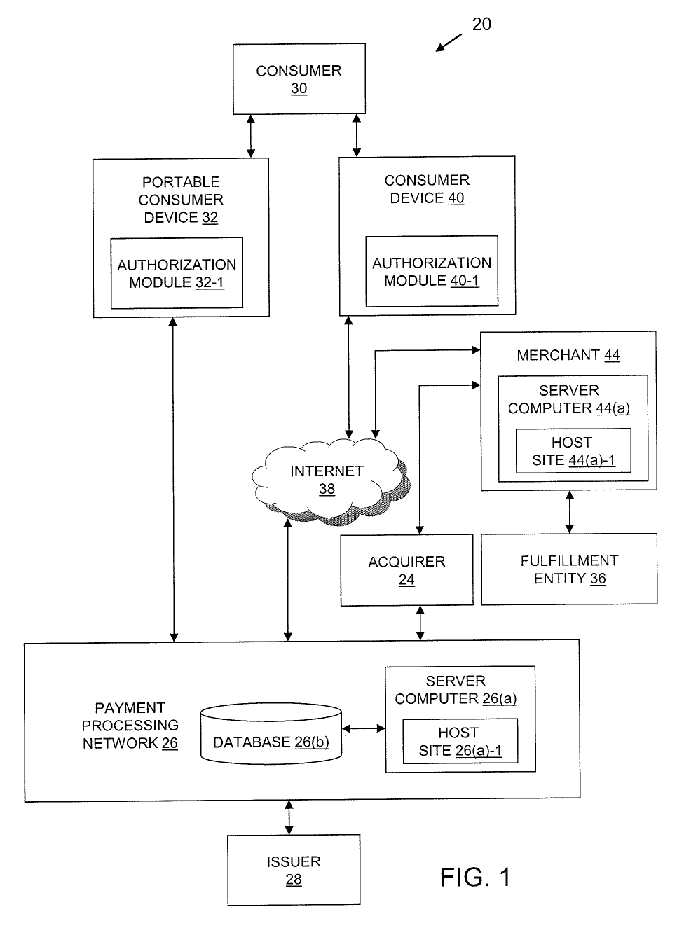

FIG. 1 is a block diagram showing a system 20 for conducting an electronic payment transaction. The system 20 includes a merchant 44 that communicates with a consumer 30 using a consumer device 40 and the Internet 38 or other data transfer network. Alternatively, the merchant 44 may communicate with the consumer 30 via a telephone or other voice or data communication means. Both telephone and Internet transactions are typically characterized as “card-not-present (CNP)” transactions. CNP transactions are particularly susceptible to fraud and, thus, the descriptions that follow are based on CNP transactions. However, the principles can be directly applied to transactions in which the card is presented to the merchant 44, and the merchant 44 thereafter delivers some good or service to the consumer 30 after a period of time.

The consumer device 40 can be portable or non-portable in nature. For example, the consumer device 40 could be a computer terminal, television, personal or laptop computer, set-top box or the like. The consumer device 40 can run an operating system such as a Windows™ based operating system and a Web browser such as Internet Explorer™. Alternatively, the consumer device 40 may be a portable consumer device such as a cell phone, personal data assistant or the like. For example, consumer device 40 can be hand-held and compact so that it can fit into a consumer's wallet, purse or pocket.

The portable consumer device 32 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

In some embodiments, the consumer 30 may use both the consumer device 40 and the portable consumer device 32. For example, the consumer device 40 may be a laptop computer operated by the consumer 30 and the portable consumer device 32 may be a payment card used by the consumer 30. In other embodiments, the consumer 30 may have only one of these devices. For example, the consumer 30 may have a consumer device 40 in the form of a mobile phone. The mobile phone may serve as both a communication device which allows a consumer to buy goods or services from the merchant 44, and may also be used as a payment mechanism for traditional card present types of transactions.

The consumer 30 may be an individual, or an organization such as a business, school hospital etc., that is capable of purchasing goods or services.

The merchant 44 may be any entity which offers goods, services, money transfer or access transactions. In the embodiment shown in FIG. 1, the merchant 44 includes a server computer 44(a) as well as a host site 44(a)-1. The host site 44(a)-1 typically implements an Internet website. The server computer 44(a) may have a computer readable medium comprising code for performing the functions that the merchant 44 performs. The server computer 44(a) may comprise a processor; and a computer readable medium coupled to the processor, wherein the computer readable medium comprises code executable by the processor, the computer readable medium comprising (i) code for sending an authorization request message associated with a transaction, (ii) code for receiving an authorization response message approving the transaction, (iii) code for receiving a termination message after receiving the authorization response message, (iv) code for initiating a termination process for the transaction, and (v) code for sending a chargeback message.

The merchant 44 may be in communication with a number of other entities such as an acquirer 24 or a fulfillment entity 36.

An acquirer 24 can be in operative communication with the merchant 44. Acquirer 24 is typically a financial institution which maintains an account for the merchant 44. The merchant 44 may communicate with the acquirer 24 directly through a secure payment channel in some embodiments.

The fulfillment entity 36 may comprise any suitable entity that can fulfill the good(s) and/or service(s) that was purchased by the consumer 30. For example, the fulfillment entity 36 may be an entity that is separate and distinct from the merchant 44. Examples of such separate and distinct entities include shipping or packing companies, warehouses, middlemen, etc. In other embodiments, the fulfillment entity 36 need not be present, as the merchant 44 could do practically everything (e.g., packing, shipping, etc.) to fulfill the consumer's purchase.

The system 20 also comprises a payment processing network 26, which may include a server computer 26(a) which includes a host site 26(a)-1. The server computer 26(a) (and also server computer 44(a)-1) is typically a powerful computer or cluster of computers. For example, the server computer 26(a) can be a large mainframe, a minicomputer cluster, or a group of servers functioning as a unit. In one example, the server computer 26(a) may include a database server 26(b) coupled to a Web server. The server computer 26(a) may comprise a processor; and a computer readable medium coupled to the processor, wherein the computer readable medium comprises code executable by the processor, the computer readable medium comprising (i) code for receiving an authorization request message, wherein the authorization request message is associated with a transaction, (ii) code for sending an authorization response message authorizing the transaction, (iii) code for sending a transaction alert message to a consumer device, wherein the transaction alert message includes information identifying the transaction, (iv) code for receiving an alert response message indicating that the transaction is not authorized, (v) code for sending a termination message, and (vi) code for receiving a chargeback message after sending the termination message.

In addition, the payment processing system 26 may include data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The merchant 44 may communicate with the issuer 28 via the payment processing network 26. The issuer 28 may hold an account associated with the portable consumer device 32. For example, the portable consumer device 32 may be in the form of a credit, debit, or prepaid card. The issuer 28 may hold an account associated with the credit, debit, or prepaid card.

II. Methods

In an Internet-based transaction, the user may use the consumer device 40 to log onto the merchant's host site 44(a)-1 and initiate a transaction to purchase one or more items. The consumer 30 may use an account number associated with the portable consumer device 32. In response, a processor in the merchant's server computer 44(a) generates an authorization request message. The server computer 44(a) sends the authorization request message to the issuer 28, via the payment processing network 26 and the acquirer 24. In some instances, the issuer 28 may operate its own server computer (not shown), which may have a computer readable medium comprising code for performing one or more the functions that the issuer 28, payment processing network 26, or both perform.

After the issuer 28 receives the authorization request message, the issuer 28 approves or declines the transaction and sends an authorization response message to the server computer 26(a) in the payment processing network 26 to indicate whether or not the current transaction is authorized. The server computer 26(a) in the payment processing network 26 then forwards the authorization response message to the acquirer 24. The acquirer 24 may use its own server computer (not shown) and may in turn send the authorization response message back to the server computer 44(a) operated by the merchant 44. At this point, the transaction is authorized and processing of the order can proceed.

At approximately the same time (e.g., within 5 or 10 seconds) that the payment processing network 26 sends the authorization response message to the merchant 44, it also sends a transaction alert message to the consumer 30, via the consumer device 40 or another consumer device such as the portable consumer device 32.

The transaction alert message provides the consumer 30 with an opportunity to authenticate or repudiate the transaction. For example, the consumer devices 32, 40 may comprise authorization modules 32-1, 40-1, respectively. The authorization modules 32-1, 40-1 may comprise any suitable hardware and/or software. The transaction alert message may be sent to the portable consumer device 32 or the consumer device 40 as an email, instant message (e.g., SMS message), etc.

In some cases, even after receiving the transaction alert message, the portable consumer device 32 or the consumer device 40 may be unavailable to respond to the receipt of the transaction alert message. For example, the portable consumer device 32 may be turned off or outside the coverage area of the wireless network, or the consumer 30 may not be available (e.g., the consumer 30 is asleep). In one aspect, the transaction may be considered authenticated if no response is received from the portable consumer device 32 within a time-out period. In another aspect, the transaction may be considered repudiated if no response is received from the portable consumer device 32 within the time-out period. While the system awaits a response from one of the authorization modules 32-1 and 40-1, the transaction is authorized and processing of the order can proceed.

For example, in one aspect, the system 20 includes a fulfillment entity 36 that processes and ships the order or provides the service associated with the transaction. In some implementations, the fulfillment entity 36 may be the same entity as the merchant 44. In other cases, the fulfillment entity 36 may be a separate entity. In some aspects, the merchant 44 sends an order request message to the fulfillment entity 36 in response to the authorization response message.

If either the consumer device 32 or 40 repudiates the transaction, either by sending an alert response message or due to a time-out, the server computer 26(a) in the payment processing network 26 sends a chargeback request message or escrow termination message to the merchant 44. In turn, the merchant 44 sends an order cancellation message to the fulfillment entity 36. The fulfillment entity 36 aborts the order processing operation and the merchant 44 sends a chargeback response message to the payment processing network 26.

On the other hand, if either the consumer device 32 or 40 authenticates the transaction, either by sending an alert response message or due to a time-out, the order processing continues to completion. In this way, the system 20 takes advantage of the natural delay between order placement and fulfillment to allow the consumer 30 to repudiate a fraudulent transaction without incurring the delay associated with awaiting the alert response message prior to authorizing the transaction.

In another aspect, the merchant 44 enters an escrow period in response to receiving the authorization response message. For example, the server computer 44(a) of the merchant 44 may have previously stored a specified fulfillment delay associated with the fulfillment entity 36. The specified fulfillment delay predicts the minimum, mean, average or some other estimated amount of time in which an order will be fulfilled. For example, the specific fulfillment entity 36 may specify that the fulfillment entity 36 only ships merchandise at the close of business on Tuesdays and Fridays. If there is an escrow period associated with a transaction, the merchant 44 enters an escrow holding period until the remaining time in the escrow period is approximately equal to the specified fulfillment delay. In this way, the consumer 30 can be given an amount of time in which to respond while continuing to take advantage of the natural delay between order placement and fulfillment.

In one aspect, the system 20 enables the merchant 44, payment processing network 26, issuer 28, acquirer 24, consumer 30 or combination of two or more of these to specify whether the transaction is associated with an escrow period. In another aspect, the system 20 allows one or more of the entitles to specify the duration of the escrow period, either globally or associated with a particular transaction, transaction type, merchant, costumer or fulfillment entity.

If an alert response message is received at the payment processing network 26 from the portable consumer device 32 or the consumer device 40 during the escrow holding period, the server computer 26(a) in the payment processing network 26 sends an escrow termination message or chargeback request message. If the escrow termination message indicates that the transaction has been authorized by the consumer 30, the merchant 44 either does nothing if the order request message has been sent to the fulfillment entity 36 or terminates the escrow holding period and sends the order request message to the fulfillment entity 36, if the order request message has not yet been sent. If the escrow termination message indicates that the transaction has been repudiated by the consumer 30, and if the order request has been sent to the fulfillment entity 36, the merchant 44 sends an order cancellation message to the fulfillment entity 36 and sends a chargeback message to the payment processing network 26. If the escrow termination message indicates that the transaction has been repudiated by the consumer 30 and the order request has not been sent to the fulfillment entity 36, the merchant 44 simply sends a chargeback message to the payment processing network 26.

Depending on the implementation and circumstances, the system discussed herein provides for fewer unauthorized purchases because the consumer is given a reasonable, sometimes controllable, amount of time to alert the payment processing network or issuer of an unauthorized purchase. In addition, the end-to-end fulfillment delay is reduced in comparison with systems in which authorization from the payment processing network to the merchant is delayed while awaiting a response from the consumer device. Because the escrow period can be varied from transaction to transaction, a longer escrow period can be specified for particularly suspect transactions or when delay is not critical. A shorter or no escrow period can be used when time is of the essence, such as when a pizza is ordered.

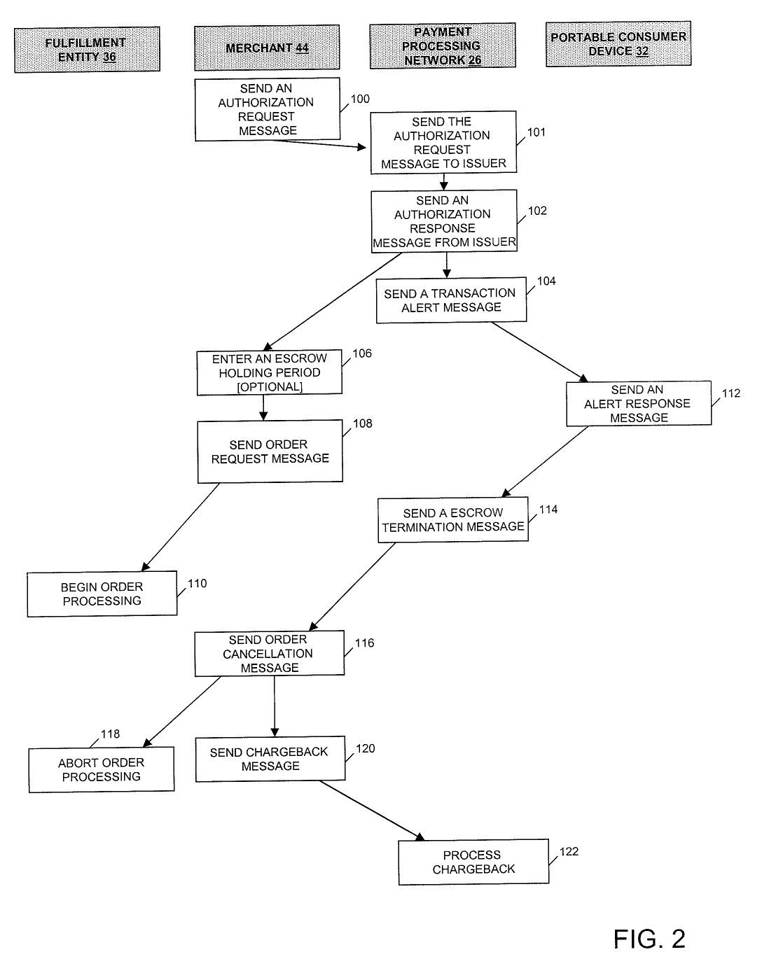

FIG. 2 is a exemplary flow chart showing one possible message flow. In block 100, the merchant 44 sends an authorization request message associated with a transaction to the payment processing network 26. The server computer 44(a) in the payment processing network 26 receives the authorization request message, and then forwards it to the issuer 28 (block 101). The issuer 28 may then authorize or not authorize the transaction (e.g., due to insufficient funds or credit in the consumer's account). After the issuer 28 decides whether or not to authorize the transaction, the server computer 26(a) in the payment processing network 26 can receive an authorization response message generated by a server computer at the issuer 28. In block 102, the server computer 26(a) in the payment processing network 26 sends an authorization response message authorizing the transaction to the merchant 44 (via the acquirer 24).

In one aspect, either the authorization request message or the authorization response message includes an escrow request. In another aspect, either the authorization request message or the authorization response message indicates an escrow period. In another aspect, the authorization request message includes an escrow request and the transaction alert message is sent in response thereto.

In the same general time frame as it sends the authorization response message, the server computer 26(a) in the payment processing network 26 sends a transaction alert message including information identifying the transaction to the portable consumer device 32 in block 104. Such information may include the time of the transaction, the date of the transaction, the merchant's name, the total amount of the purchase, and a portable consumer device identifier (e.g., the last four digits of the account number). In some aspects, block 104 is executed after block 102. In some aspects, the authorization request message indicates a card-not-present transaction and the payment processing network 26 sends the transaction alert message (block 104) in response thereto.

In block 106, the server computer 44(a) at the merchant 44 receives the authorization response message approving the transaction. In one aspect, the merchant 44 sends an order request message to a fulfillment entity 36 in block 108.

Optionally, the merchant 44 enters an escrow holding period in block 106. The duration of the escrow holding period may depend on several factors. For example, an escrow period may be specified for this specific transaction, based on the type or the characteristics of the transaction, by the merchant, by the payment processing network, etc. In one aspect, the fulfillment entity 36 sends a specified fulfillment delay estimating the actual fulfillment delay. Such a value may be sent before the transaction is initiated (e.g. before block 100) or it may be sent after the transaction is initiated (e.g. after block 100). It may be sent in response to a request made by the merchant 44 and may be specifically associated with the transaction. In one aspect, the merchant 44 is configured to calculate the escrow holding period so that it is approximately equal to the difference between the escrow period and the specified fulfillment delay.

As shown in FIG. 2, if no escrow termination message is received from the server computer 26(a) in the payment processing network 26, when a remaining period of the escrow period is approximately equal to the fulfillment delay, the server computer 44(a) at the merchant 44 sends an order request message to a fulfillment entity 36 in block 108. In block 110, the fulfillment entity 36 receives the order request message and begins to process the order.

In block 112, the portable consumer device 32 (or the consumer device 40) receives the transaction alert message from the server computer 26(a) in the payment processing network 26, and, according to the flow shown in FIG. 2, responds with an alert response message repudiating the transaction. The server computer 26(a) in the payment processing network 26 receives the alert response message and sends an escrow termination message to the server computer 44(a) operated by the merchant 44 (block 114). In one aspect, the escrow termination message includes a chargeback request. In another aspect, the escrow termination message is a chargeback request message. Typically, the authorization response message is sent (such as in block 102) before the alert response message is received (such as in block 114).

In response to the escrow termination message, the server computer 44(a) operated by the merchant 44 sends an order cancellation message to another computer operated by the fulfillment entity 36, in block 116. The server computer 44(a) then sends a chargeback request message to the server computer 26(a) in the payment processing network 26, in block 120. In block 118, the fulfillment entity 36 aborts the ordering process. In block 122, the payment processing network 26 processes the chargeback and communicates with the issuer 28 to ensure that either the consumer's account is not debited, or if it has been debited, then it is credited with an amount equal to the amount of the transaction.

If an escrow termination message is received during the escrow holding period and indicates that the transaction has been authenticated by the consumer 30, the merchant 44 terminates the escrow holding period and sends an order request message to the fulfillment entity 36, in a similar manner as shown in block 108.

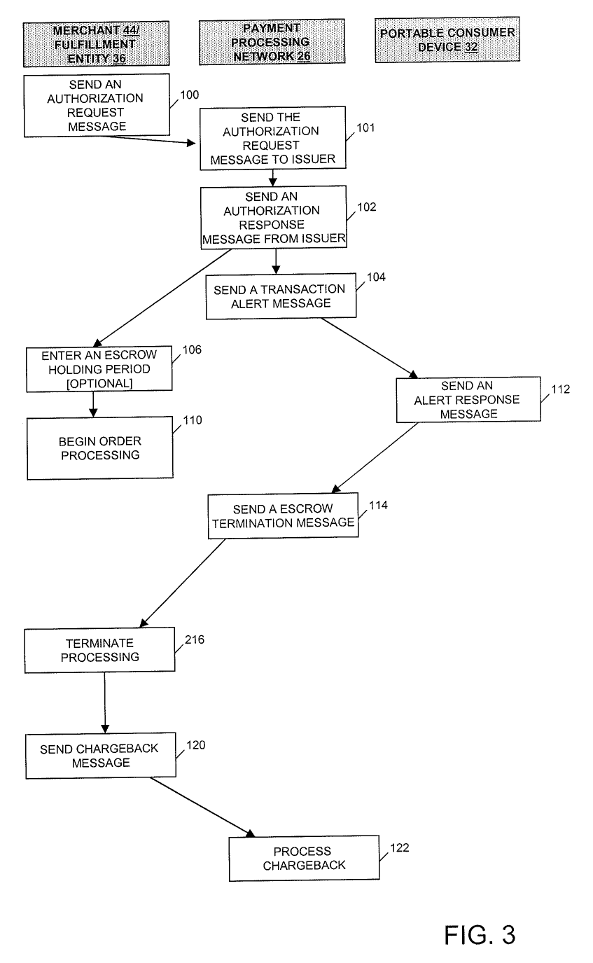

Another embodiment of the invention is shown in FIG. 3. The flowchart in FIG. 3 has steps that are similar to those in FIG. 2, and descriptions of like numerals are not repeated here. In the method of FIG. 3, the merchant 44 and the fulfillment entity 36 are the same. For example, an Internet merchant 44 that sells books, may receive orders for book, may retrieve them from storage, and may pack and ship them to the consumer 30. As the merchant 44/fulfillment entity 36 are one in the same, a separate “order cancellation message” (see step 116 in FIG. 2) need not be generated or sent. Rather, after receiving an escrow termination message (block 214), the merchant 44/fulfillment entity 36 may simply terminate processing of the order (block 216). The merchant's server computer 44(a) may simply indicate that the order is canceled, and further processing of the purchase may stop and/or any processing that has taken place to date may be reversed.

III. Portable Consumer Devices and Computer Apparatuses

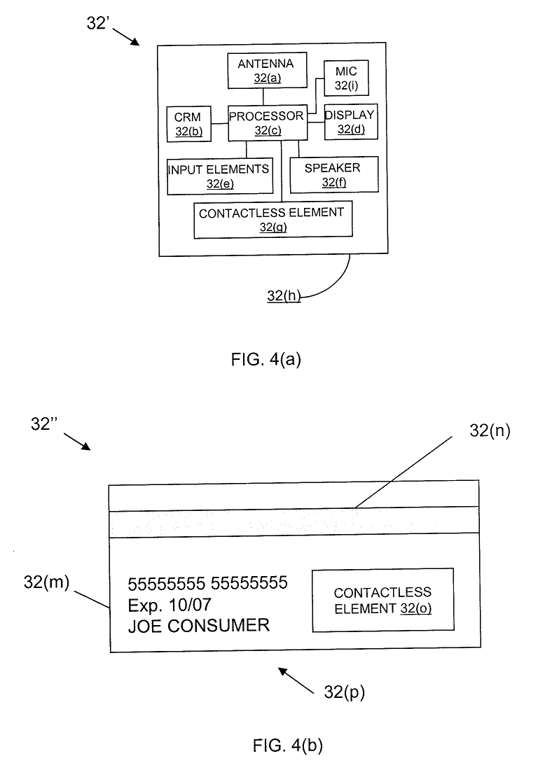

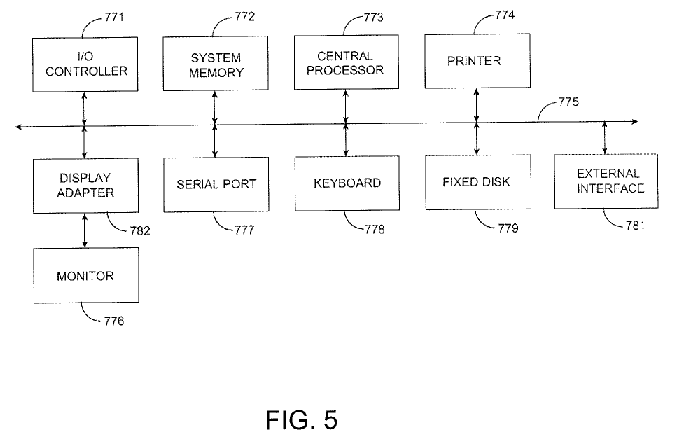

FIGS. 4(a), 4(b), and 5 show block diagrams of portable computer devices and subsystems that may be present in computer apparatuses in systems according to embodiments of the invention.

The portable consumer device 32 may be in any suitable form. For example, suitable portable consumer devices can be hand-held and compact so that they can fit into a consumer's wallet and/or pocket (e.g., pocket-sized). Examples of portable consumer devices include cellular phones (e.g., the phone described above), personal digital assistants (PDAs), pagers, transponders, and the like. The portable consumer devices can also be debit devices, credit devices, or stored value devices.

An exemplary portable consumer device 32′ in the form of a phone may comprise a computer readable medium and a body as shown in FIG. 4(a). (FIG. 4(a) shows a number of components, and the portable consumer devices according to embodiments of the invention may comprise any suitable combination or subset of such components.) The computer readable medium 32(b) may be present within the body 32(h), or may be detachable from it. The body 32(h) may be in the form a plastic substrate, housing, or other structure. The computer readable medium 32(b) may be a memory that stores data and may be in any suitable form including a magnetic stripe, a memory chip, uniquely derived keys (such as those described above), encryption algorithms, etc. The memory also preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. Any of this information may be transmitted by the portable consumer device 32′.

Information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The portable consumer device 32′ may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) portable consumer device 32′ and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 32′ and an interrogation device. Thus, the portable consumer device 32′ is capable of communicating and transferring data and/or control instructions via both cellular network and near field communications capability.

The portable consumer device 32′ may also include a processor 32(c) (e.g., a microprocessor) for processing the functions of the portable consumer device 32′ and a display 32(d) to allow a consumer to see phone numbers and other information and messages. The portable consumer device 32′ may further include input elements 32(e) such as buttons to allow a consumer to input information into the device, a speaker 32(f) to allow the consumer to hear voice communication, music, etc., and a microphone 32(i) to allow the consumer to transmit her voice through the portable consumer device 32′. The portable consumer device 32 may also include an antenna 32(a) for wireless data transfer (e.g., data transmission).

An example of a portable consumer device 32″ in the form of a card is shown in FIG. 4(b). FIG. 4(b) shows a plastic substrate 32(m). A contactless element 32(o) for interfacing with an access device may be present on or embedded within the plastic substrate 32(m). Consumer information 32(p) such as an account number, expiration date, and consumer name may be printed or embossed on the card. Also, a magnetic stripe 32(n) may also be on the plastic substrate 32(m).

As shown in FIG. 4(b), the portable consumer device 32″ may include both a magnetic stripe 32(n) and a contactless element 32(o). In other embodiments, both the magnetic stripe 32(n) and the contactless element 32(o) may be in the portable consumer device 32″. In other embodiments, either the magnetic stripe 32(n) or the contactless element 32(o) may be present in the portable consumer device 32″.

The various participants and elements in FIG. 1 may operate one or more computer apparatuses to facilitate the functions described herein. Any of the elements in FIG. 1 (e.g., the server computers, the consumer device 40, etc.) may use any suitable number of subsystems to facilitate the functions described herein. Examples of such subsystems or components are shown in FIG. 5. The subsystems shown in FIG. 5 are interconnected via a system bus 775. Additional subsystems such as a printer 774, keyboard 778, fixed disk 779 (or other memory comprising computer readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

Embodiments of the invention are not limited to the above-described embodiments. For example, although separate functional blocks are shown for an issuer, payment processing system, and acquirer, some entities perform all of these functions in some implementations.

It should be understood that the embodiments as described above can be implemented in the form of control logic using computer software in a modular or integrated manner. Based on the disclosure and teachings provided herein, a person of ordinary skill in the art will know and appreciate other ways and/or methods to implement the disclosed aspects using hardware as well as a combination of hardware and software.

Any of the software components or functions described herein may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk or an optical medium such as a CD-ROM. Any such computer readable medium may reside on or within a single computational apparatus, and may be present on or within different computational apparatuses within a system or network. Embodiments of the invention include computer program products, comprising a computer usable medium having a computer readable program code embodied therein, the computer readable program code adapted to be executed to implement any of the above-described methods.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A server computer comprising:
a processor; and
a computer readable medium coupled to the processor, wherein the computer readable medium comprises code executable by the processor, the computer readable medium comprising (i) code for receiving an authorization request message, wherein the authorization request message is associated with a transaction, (ii) code for sending an authorization response message authorizing the transaction, (iii) code for sending a transaction alert message to a consumer device, wherein the transaction alert message includes information identifying the transaction, (iv) code for receiving an alert response message indicating that the transaction is not authorized, (v) code for sending a termination message, and (vi) code for receiving a chargeback message after sending the termination message.

2. The server computer of claim 1 wherein the transaction is a card not present type of transaction.

3. The server computer of claim 1 wherein the consumer device is a mobile phone.

4. The server computer of claim 1 wherein the termination message is sent to a merchant that is conducting the transaction with a consumer.

5. The server computer of claim 1 wherein the termination message is sent to a merchant that is conducting the transaction with a consumer, and wherein the merchant thereafter sends an order cancellation message to a fulfillment entity, wherein the fulfillment entity is configured to fulfill the transaction by supplying a good that has been purchased by the consumer.

6. A method comprising:
receiving an authorization request message at a server computer, wherein the authorization request message is associated with a transaction;
using the server computer, sending an authorization response message authorizing the transaction;
using the server computer, sending a transaction alert message to a consumer device, wherein the transaction alert message includes information identifying the transaction;
receiving an alert response message at the server computer indicating that the transaction is not authorized;
using the server computer, sending a termination message; and
receiving a chargeback message at the server computer after sending the termination message.

7. The method of claim 6 wherein the transaction is a card not present type of transaction.

8. The method of claim 6 wherein the consumer device is a mobile phone.

9. The method of claim 6 wherein the termination message is sent to a merchant that is conducting the transaction with a consumer.

10. The method of claim 6 wherein the termination message is sent to a merchant that is conducting the transaction with a consumer, and wherein the merchant thereafter sends an order cancellation message to a fulfillment entity, wherein the fulfillment entity is configured to fulfill the transaction by supplying a good that has been purchased by the consumer.

11. A server computer comprising:
a processor; and
a computer readable medium coupled to the processor, wherein the computer readable medium comprises code executable by the processor, the computer readable medium comprising (i) code for sending an authorization request message associated with a transaction, (ii) code for receiving an authorization response message approving the transaction, (iii) code for receiving a termination message after receiving the authorization response message, (iv) code for initiating a termination process for the transaction, and (v) code for sending a chargeback message.

12. The server computer of claim 11 wherein code for initiating the termination process for the transaction includes code for sending an order cancellation message to a fulfillment entity.

13. The server computer of claim 11 wherein the code for initiating the termination process for the transaction includes code for terminating processing for the transaction.

14. The server computer of claim 11 wherein the transaction is a card not present type of transaction.

15. The server computer of claim 11 wherein the server computer is a merchant server computer.

16. A method comprising:
using a server computer, sending an authorization request message associated with a transaction;
receiving an authorization response message approving the transaction at the server computer;
receiving a termination message at the server computer after receiving the authorization response message;
initiating a termination process for the transaction; and
sending a chargeback message.

17. The method of claim 16 wherein initiating the termination process for the transaction includes sending an order cancellation message to a fulfillment entity.

18. The method of claim 16 wherein initiating the termination process for the transaction includes terminating processing for the transaction.

19. The method of claim 16 wherein the transaction is a card not present type of transaction.

20. The method of claim 16 wherein the server computer is a merchant server computer.
